(19) United States
(12) Patent Application Publication
(10) Pub. No.: US 2025/0317172 A1
(43) Pub. Date: Oct. 9, 2025

(54) METHOD AND APPARATUS FOR GENERATING BEAMFORMING VECTOR USING NEURAL NETWORK MODEL BASED ON FEATURE REFLECTING DISTRIBUTED INFORMATION OF BASE STATION

(71) Applicant: KOREA UNIVERSITY RESEARCH AND BUSINESS FOUNDATION, Seoul (KR)

(72) Inventors: In Kyu LEE, Seoul (KR); Min Seok KIM, Seoul (KR)

(21) Appl. No.: 18/937,364

(22) Filed: Nov. 5, 2024

(30) Foreign Application Priority Data
Apr. 5, 2024 (KR) 10-2024-0046770

(51) Int. Cl. H04B 7/06

(52) U.S. Cl. CPC H04B 7/0617; H04B 7/0626; H04B 7/0634

(57) ABSTRACT

The present invention relates to a technique of generating an optimal beamforming vector through a neural network model based on feature values that reflect distributed information of a base station constituting a Multiple Input Single Output Interference Channel (MISO IC) system.

### CROSS-REFERENCE TO RELATED APPLICATION

The present application claims the benefit of priority to Korean Patent Application No. 10-2024-0046770, filed on Apr. 5, 2024, in the Korean Intellectual Property Office, the entire contents of which is incorporated herein for all purposes by this reference.

### BACKGROUND OF THE INVENTION

### Field of the Invention

The present invention relates to a technique of generating an optimal beamforming vector through a neural network model based on feature values that reflect distributed information of a base station constituting a Multiple Input Single Output Interference Channel (MISO IC) system.

### Background of the Related Art

The beamforming technique is a technique of focusing wireless signals in a specific direction using multiple antennas, and this is important for controlling interference that has a significant impact on network performance. In particular, researches on the beamforming technique are actively conducted in multi-cell networks where inter-cell interference has a significant impact on performance.

In the past, in order to effectively perform beamforming in a multi-cell network, a method of performing complex calculations based on global Channel State Information (CSI) collected from all cells has been performed mainly. Accordingly, a method of calculating a beamforming vector based on deep learning is studied as a promising alternative to improve beamforming algorithms that require complex calculations.

The method of deriving beamforming using deep learning replaces the complex calculation process with the learning process of an artificial neural network, and allows the process of determining a beamforming strategy to be calculated with simple matrix operations in the process of actually using the artificial neural network.

However, the method of training the beamforming strategy by inputting all the global CSI information into an artificial neural network has a problem of performance degradation and increased computational complexity as the network size increases. In addition, since beamforming calculation based on deep learning using global CSI should share a beamforming solution calculated in a central processing unit with all base stations, there is a problem in that the backhaul overhead for information exchange increases excessively when it is applied to a multi-cell network.

Accordingly, a distributed beamforming calculation method that calculates a beamforming solution directly in a local base station using local channel information that can be secured in each base station is required.

### SUMMARY OF THE INVENTION

The problem to be solved by the present invention is to propose a technique that achieves reduced computational complexity and improved performance without being relatively affected by the network size by using a deep learning model trained based on local channel information that can be secured in each base station and feature values essential for beamforming determination.

Meanwhile, the technical problems of the present invention are not limited to the technical problems mentioned above, and unmentioned other technical problems can be clearly understood by those skilled in the art from the following description.

A method performed by a beamforming vector generation apparatus operated by a processor according to an embodiment may comprise: an operation of acquiring local channel information for base station k (k is identification information of a base station) among base stations constituting a MISO IC, weight information of base station k, and passive interference information of other base stations affecting a control signal strength of base station k; an operation of deriving active interference information of base station k affecting a control signal strength of other base stations based on a first neural network model learned to derive active interference information for generating a beamforming vector of a preset purpose from the local channel information, the weight information, and the passive interference information; an operation of deriving a dual variable of base station k based on a second neural network model trained to derive a dual variable for generating a beamforming vector of a preset purpose from the local channel information, the passive interference information, and the active interference information; and an operation of deriving a beamforming vector of base station k based on the passive interference information, the active interference information, and the dual variable using a beam recovery function.

In addition, the local channel information for base station k may include Channel State Information (CSI) of base station k affecting other receivers, and the weight information of base station k may include weight information set in advance for base station k among the base stations constituting the MISO IC.

In addition, the first neural network model and the second neural network model may be trained based on an interference temperature constraint configured of scalar information as a feature value reflecting distribution information of base stations constituting the MISO IC, and each of the base stations constituting the MISO IC may include the same first neural network model and second neural network model.

In addition, the beamforming vector of a preset purpose may be a beamforming vector that maximizes an achievable transmission rate that can be achieved by base station k based on [Equation 1].

$${R}_{k} ( H , W ) = {log}_{2} ( 1 + \frac{{\vert {h}_{kk}^{H} {w}_{k} \vert}^{2}}{{\sum }_{j \neq k} {\vert {h}_{jk}^{H} {W}_{j} \vert}^{2} + {σ}^{2}} ) \\ where \\ H {=}^{△} \{ {h}_{k} : {∀}_{k} \} ∈ {ℂ}^{{M}_{T} K \times K} , \\ W {=}^{△} \{ {w}_{k} : {∀}_{k} \} ∈ {ℂ}^{{M}_{T} K \times K} \qquad [ Equation 1 ]$$

(r is the achievable transmission rate of a base station, w is the beamforming vector, h is the local channel information, c is interference information between base stations affecting the control signal strength, subscript is the identification information of the base station, and subscript kj is a subscript indicating information on base station k affecting base station j.)

In addition, conditions for achieving the beamforming vector of [Equation 1] include [Equation 2] to [Equation 4] shown below.

$$L ( {w}_{k} , {d}_{k} ; {h}_{k} , {\check{c}}_{k} , {\hat{c}}_{k} ) = {log}_{2} ( 1 + \frac{{\vert {h}_{kk}^{H} {w}_{k} \vert}^{2}}{{\sum }_{j \neq k} {c}_{jk} + {σ}^{2}} ) - {\sum }_{j \neq k} {d}_{kj} ( {\vert {h}_{k j}^{H} {w}_{k} \vert}^{2} - {c}_{kj} ) - {d}_{kk} ( {‖ {w}_{k} ‖}^{2} - P ) \qquad [ Equation 2 ]$$

(L is a Lagrangian function, w is the beamforming vector, h is the local channel information, c is the interference information between base stations affecting the control signal strength, čₖ in c is the passive interference information of other base stations affecting the control signal strength of base station k, ĉₖ in c is the active interference information of base station k affecting the control signal strength of other base stations, d is the dual variable, subscript k is the identification information of the base station, and subscript kj is a subscript indicating information on base station k affecting base station j.)

$$g ( {d}_{k} ; {h}_{k} , {\check{c}}_{k} , {\hat{c}}_{k} ) = {max}_{{w}_{k}} L ( {w}_{k} , {d}_{k} ; {h}_{k} , {\check{c}}_{k} , {\hat{c}}_{k} ) \qquad [ Equation 3 ]$$

(g is the dual function, w is the beamforming vector, d is the dual variable, h is the local channel information, c is the interference information between base stations affecting the control signal strength, čₖ in c is the passive interference information of other base stations affecting the control signal strength of base station k, ĉₖ in c is the active interference information of base station k affecting the control signal strength of other base stations, subscript k is the identification information of the base station, and subscript kj is a subscript indicating information on base station k affecting base station j.)

$${w}_{k} = V ( {h}_{k} , {\check{c}}_{k} , {d}_{k} ) {=}^{△} \sqrt{{p}_{k}} {A}_{k}^{- 1} {h}_{kk} \\ where \\ {A}_{k} {=}^{△} {\sum }_{j \neq k} {d}_{kj} {h}_{kj} {h}_{kj}^{H} + {d}_{kk} I \\ {p}_{k} {=}^{△} {( \frac{1}{ln 2} - \frac{{\sum }_{j \neq k} {c}_{jk} + {σ}^{2}}{{‖ {A}_{k}^{- \frac{1}{2}} {h}_{kk} ‖}^{2}} )}^{+} \frac{1}{{‖ {A}_{k}^{- \frac{1}{2}} {h}_{kk} ‖}^{2}} \qquad [ Equation 4 ]$$

(w is the beamforming vector, V is the beam recovery function, h is the local channel information, čₖ in c is the passive interference information of other base stations affecting the control signal strength of base station k, d is the dual variable, subscript k is the identification information of the base station, and subscript kj is a subscript indicating information on base station k affecting base station j.)

In addition, the first neural network model may be trained in a direction that maximizes an expected value of an achievable transmission rate of the base station according to a predetermined objective function, and include parameters learned a to derive active interference information for generating beamforming vector of the preset purpose from the local channel information, the weight information, and the passive interference information.

In addition, the objective function of the first neural network model may include [Equation 5].

$${J}_{C}^{[ t ]} ( {θ}_{C} ) = {𝔼}_{ℋ , ℳ} [ u ( \{ {r}_{k}^{[ t - 1 ]} ( {h}_{k} , {\check{c}}_{k} , {\hat{c}}_{k} ) : {∀}_{k} \} , μ ) ] \\ where \\ {r}_{k}^{[ t ]} ( {h}_{k} , {\check{c}}_{k} , {\hat{c}}_{k} ) = {log}_{2} ( 1 + \frac{{\vert {h}_{kk}^{H} V ( {h}_{k} , {\check{c}}_{k}^{[ t - 1 ]} , {d}_{k}^{[ t ]} ) \vert}^{2}}{{\sum }_{j \neq k} {c}_{jk}^{[ t - 1 ]} + {σ}^{2}} ) \\ {d}_{k}^{[ t ]} = {𝒟}_{{θ}_{D}^{[ t ]}} ( {h}_{k} , {\check{c}}_{k}^{[ t - 1 ]} , {\hat{c}}_{k}^{[ t ]} ) \\ {\check{c}}_{k}^{[ t ]} {=}^{△} \{ {c}_{jk}^{[ t ]} : ∀ j \neq k \} \qquad [ Equation 5 ]$$

(J_{c} is the first neural network model, θ_{c} is the parameter of the first neural network model, t is the epoch order, h is the local channel information, č in c is the passive interference information of other base stations affecting the control signal strength of base station k, d is the dual variable, subscript k is the identification information of the base station, subscript kj is a subscript indicating information on base station k affecting base station j, subscript H is the dataset of the local channel information of base station k, and subscript M is the dataset of the weight information of base station k.)

In addition, the second neural network model may be trained in a direction that minimizes an expected value of a dual variable according to a predetermined objective function, and include parameters learned to derive a dual variable for generating a beamforming vector of the preset objective from the local channel information, the passive interference information, and the active interference information.

In addition, the objective function of the second neural network model may include [Equation 6].

$${J}_{D}^{[ t ]} ( {θ}_{D} ) = \frac{1}{K} {\sum }_{k = 1}^{K} {𝔼}_{{ℋ}_{k} , {ℳ}_{k}} [ {q}^{[ t ]} ( {h}_{k} , {d}_{k} ) ] \\ where \\ {q}^{[ t ]} ( {h}_{k} , {d}_{k} ) {=}^{△} - {\sum }_{j \neq k} {d}_{kj} ( {\vert {h}_{kj}^{H} V ( {h}_{k} , {\check{c}}_{k}^{[ t ]} , {d}_{k}^{[ t - 1 ]} ) \vert}^{2} - {c}_{kj}^{[ t ]} ) - {d}_{kk} ( {‖ V ( {h}_{k} , {\check{c}}_{k}^{[ t ]} , {d}_{k}^{[ t - 1 ]} ‖}^{2} - P ) \qquad [ Equation 6 ]$$

(J_{D} is the second neural network model, θ_{D} is the parameter of the second neural network model, t is the number of epochs, K is the number of base stations constituting the MISO IC, h is the local channel information, č in c is the passive interference information of other base stations affecting the control signal strength of base station k, d is the dual variable, V is the beam recovery function, subscript k is the identification information of the base station, subscript kj is a subscript indicating information on base station k affecting base station j, subscript Hₖ is the dataset of the local channel information of base station k, and subscript Mₖ is the dataset of the weight information of base station k.)

In addition, as the first neural network model and the second neural network model are alternately trained in a method of learning the second neural network model after learning the first neural network model for each epoch during the learning process using the same data set of local channel information and data set of weight information, each parameter may be updated by the same samples of local channel information and weight information for each epoch.

A beamforming vector generation apparatus according to an embodiment may comprise: a memory containing instructions; and a processor performing predetermined operations based on the instructions, wherein the operations of the processor may include: an operation of acquiring local channel information for base station k (k is identification information of a base station) among base stations constituting a MISO IC, weight information of base station k, and passive interference information of other base stations affecting a control signal strength of base station k; an operation of deriving active interference information of base station k affecting a control s signal strength of other base stations based on a first neural network model learned to derive active interference information for generating a beamforming vector of a preset purpose from the local channel information, the weight information, and the passive interference information; an operation of deriving a dual variable of base station k based on a second neural network model trained to derive a dual variable for generating a beamforming vector of a preset purpose from the local channel information, the passive interference information, and the active interference information; and an operation of deriving a beamforming vector of base station k based on the passive interference information, the active interference information, and the dual variable using a beam recovery function.

### BRIEF DESCRIPTION OF THE DRAWINGS

FIG. 1 is an exemplary view showing a Multiple Input Single Output Interference Channel (MISO IC) system according to an embodiment.

FIG. 2 is a view showing the configuration of a beamforming vector generation apparatus according to an embodiment.

FIG. 3 is a flowchart illustrating the steps of the operation performed by a beamforming vector generation apparatus according to an embodiment.

FIG. 4 is an exemplary view showing an operation of deriving a beamforming vector by dividing two neural network models by a beamforming vector generation apparatus according to an embodiment of the present invention.

FIG. 5 is an exemplary view specifically showing input variables and output variables of a first neural network model, a second neural network model, and a beam recovery function according to an embodiment.

FIG. 6 is an exemplary view comparing performance for WSR when performing an embodiment using a neural network model divided into two according to an embodiment of this document and an embodiment using a neural network model set as one objective function.

FIG. 7 is an exemplary view comparing performance for Dual Convergence when performing an embodiment using a neural network model by dividing into two and an embodiment using a neural network model set as one objective function according to embodiments of this document.

FIGS. 8 and 9 are exemplary views comparing performances of ASR and AMR based on a centralized method of generating a beamforming vector, an embodiment of this document, and conventional methods, respectively.

### DETAILED DESCRIPTION OF THE PREFERRED EMBODIMENT

Details of the objects and technical configurations of the present invention and operational effects according thereto more clearly understood by the following detailed will be description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, various embodiments of the present invention are described with reference to the accompanying drawings. However, this is not intended to limit the present invention to specific embodiments, but should be understood to include various modifications, equivalents, and/or alternatives of the embodiments of the present invention.

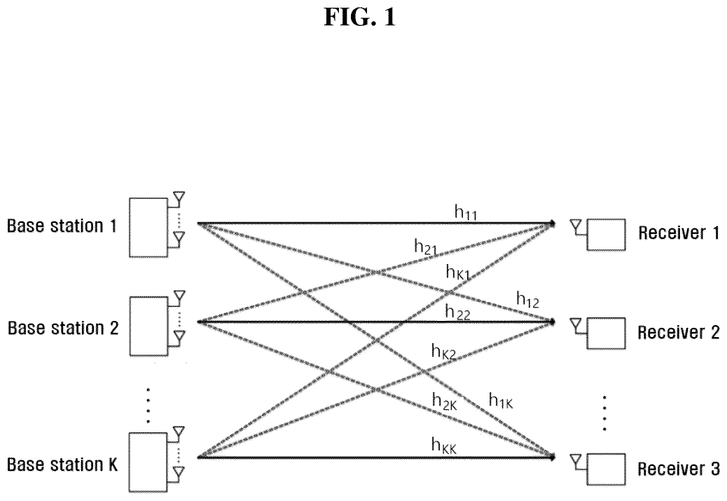

FIG. 1 is an exemplary view showing a Multiple Input Single Output Interference Channel (MISO IC) system according to an embodiment.

Referring to FIG. 1, a MISO IC according to an embodiment may include K base stations (K is a natural number greater than or equal to 2) and K receivers (K is a natural number greater than or equal to 2). At this point, when the beamforming vector at the k-th base station (hereinafter, referred to as ‘base station k’) is wₖ, power constraint on base station k is given as ∥wₖ∥²≤P. Here, P is the transmission power budget. When a channel vector from base station k to receiver j is denoted as hₖⱼ, base station k may obtain hₖ, which is local channel state information that collects channel vectors between all receivers, using a standard channel acquisition process. Channel vector hₖⱼ is defined as hₖⱼ=hₖⱼ:∀j. Accordingly, the achievable transmission rate of receiver k may be defined as shown in [Equation 1].

$${R}_{k} ( H , W ) = {log}_{2} ( 1 + \frac{{\vert {h}_{kk}^{H} {w}_{k} \vert}^{2}}{{\sum }_{j \neq k} {\vert {h}_{jk}^{H} {W}_{j} \vert}^{2} + {σ}^{2}} ) where H {=}^{△} \{ {h}_{k} : {∀}_{k} \} ∈ {ℂ}^{{M}_{T} K \times K} \\ W {=}^{△} \{ {w}_{k} : {∀}_{k} \} ∈ {ℂ}^{{M}_{T} K \times K} \qquad [ Equation 1 ]$$

At this point, the adjacent cell interference in the MISO IC generates a non-trivial trade-off between achievable transmission rates of cells. This problem may be interpreted as a problem of identifying the Pareto boundary of an achievable transmission rate region defined as R(H, W) [symbol] (R₁(H, W), . . . , R_{K}(H, W)). Here, the Pareto boundary means that there is no W′ that satisfies the condition of R_{K}(H, W′)≥R_{K}(H, W), ∀ₖ among rate tuple R(H, W).

In Multiple Input Single Output Interference Channel (MISO IC), the conventional approach is to obtain an optimal point on the Pareto boundary, as the achievable transmission rate, by solving the problem of maximizing the network utility function, which is represented as the Weighted Sum Rate Maximization (WSR) or Weighted Min Rate Maximization (WMR) problem. However, this methodology results in an algorithm accompanied with a large number of iterations on the basis of global channel state information. Accordingly, the present invention proposes the following theoretical approach to use a technique of generating an optimal beamforming vector through a deep learning model based on feature values that reflect information the distribution of base stations constituting the MISO IC.

First, the present invention may calculate a beamforming vector using the interference temperature constraint when an optimal beamforming vector is obtained in each base station.

In the embodiment of this document, the interference temperature constraint (c) is separately explained as passive interference information čₖ [symbol] {cⱼₖ:∀ⱼ≠k}∈ [symbol] ^{K-1}) of other base stations affecting the control signal strength of base station k and active interference information ĉₖ [symbol] {cₖⱼ:∀ⱼ≠k}∈ [symbol] ^{K-1} of base station k affecting the control signal strength of other base stations.

In this way, the interference temperature constraint (c) may control the signal power of the interfering link and the interfered link of each base station k. Using this concept, the centralization problem of determining the optimal point on the Pareto boundary of the MISO IC may be analyzed as a beamforming optimization problem in each base station k as shown in [Equation 2].

$${r}_{k} ( {h}_{k} , {\check{c}}_{k} , {\hat{c}}_{k} ) = {max}_{{W}_{k}} {log}_{2} ( 1 + \frac{{\vert {h}_{kk}^{H} {w}_{k} \vert}^{2}}{{\sum }_{j \neq k} {c}_{jk} + {σ}^{2}} ) \\ subject to \\ {\vert {h}_{kj}^{H} {w}_{k} \vert}^{2} \leq {c}_{kj} , {∀}_{j} \neq k \\ {‖ {w}_{k} ‖}^{2} \leq P , \qquad [ Equation 2 ]$$

(r is the achievable transmission rate of a base station, w is the beamforming vector, h is the local channel information, c is the interference information between base stations affecting the control signal strength, subscript k is the identification information of the base station, and subscript kj is the subscript indicating information on base station k affecting base station j.)

In addition, when Lagrangian analysis is performed on [Equation 2], it is as shown in [Equation 3].

$$L ( {w}_{k} , {d}_{k} ; {h}_{k} , {\check{c}}_{k} , {\hat{c}}_{k} ) = {log}_{2} ( 1 + \frac{{\vert {h}_{kk}^{H} {w}_{k} \vert}^{2}}{{\sum }_{j \neq k} {c}_{jk} + {σ}^{2}} ) - {\sum }_{j \neq k} {d}_{kj} ( {\vert {h}_{kj}^{H} {w}_{k} \vert}^{2} - {c}_{kj} ) - {d}_{kk} ( {‖ {w}_{k} ‖}^{2} - P ) \qquad [ Equation 3 ]$$

(L is the Lagrangian function, w is the beamforming vector, h is the local channel information, c is the interference information between base stations affecting the control signal strength, čₖ in c is the passive interference information of other base stations affecting the control signal strength of base station k, ĉₖ in c is the active interference information of base station k affecting the control signal strength of other base stations, d is the dual variable, subscript k is the identification information of the base station, and subscript kj is the subscript indicating information on base station k affecting base station j.)

In addition, when Lagrangian analysis is applied to [Equation 2] and [Equation 3], dual function g as shown in [Equation 4] and an equation for the optimal beamforming vector as shown in [Equation 5] are derived.

$$g ( {d}_{k} ; {h}_{k} , {{c}^{⋁}}_{k} , {\hat{c}}_{k} ) = {max}_{{w}_{k}} L ( {w}_{k} , {d}_{k} ; {h}_{k} , {{c}^{⋁}}_{k} , {\hat{c}}_{k} ) \qquad [ Equation 4 ]$$

(g is the dual function, w is the beamforming vector, d is the dual variable, h is the local channel information, c is the interference information between base stations affecting the control signal strength, čₖ in c is the passive interference information of other base stations affecting the control signal strength of base station k, ĉₖ in c is the active interference information of base station k affecting the control signal strength of other base stations, subscript k is the identification information of the base station, and subscript kj is the subscript indicating information on base station k affecting base station j.)

$${w}_{k} = V ( {h}_{k} , {{c}^{⋁}}_{k} , {d}_{k} ) {=}^{Δ} \sqrt{{p}_{k}} {A}_{k}^{- 1} {h}_{kk} \qquad [ Equation 5 ]$$

$$where {A}_{k} {=}^{Δ} {\sum }_{j \neq k} {d}_{kj} {h}_{kj} {h}_{kj}^{H} + {d}_{kk} I$$

$${p}_{k} {=}^{Δ} {( \frac{1}{ln 2} - \frac{{\sum }_{j \neq k} {c}_{jk} + {σ}^{2}}{{‖ {A}_{k}^{- \frac{1}{2}} {h}_{kk} ‖}^{2}} )}^{+} \frac{1}{{‖ {A}_{k}^{- \frac{1}{2}} {h}_{kk} ‖}^{2}}$$

(w is the beamforming vector, V is the beam recovery function, h is the local channel information, čₖ in c is the passive interference information of other base stations affecting the control signal strength of base station k, d is the dual variable, subscript k is the identification information of the base station, and subscript kj is the subscript indicating information on base station k affecting base station j.)

Here, referring to [Equation 5], it can be seen that the feature values that determine the optimal beamforming vector wₖ has passive interference information čₖ and a dual variable dₖ. In addition, since the active interference information ĉₖ performs a function of identifying the dual variable, it can be finally defined that the active interference information ĉₖ, the passive interference information čₖ, and the dual variable dₖ are the feature values that determine the optimal beamforming vector.

In the present invention, the active interference information ĉₖ, passive interference information čₖ, and dual variable dₖ are used as feature values of a neural network model required for learning to calculate a beamforming vector based on the theoretical approach described above.

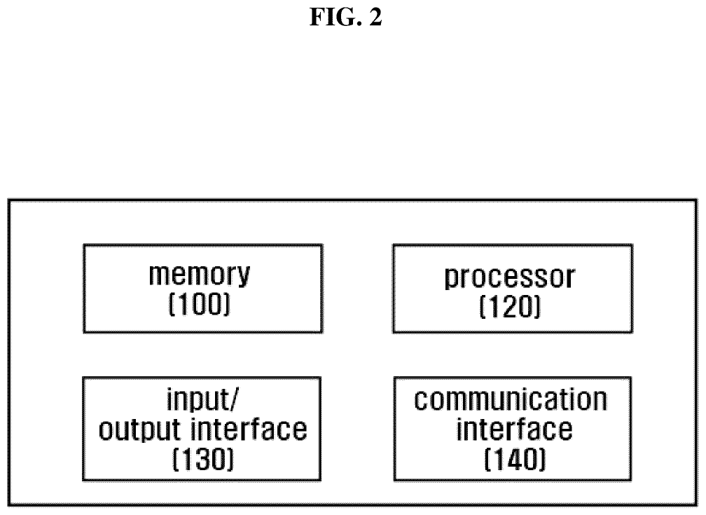

In addition, according to the equation described above, according to the point that the active interference information ĉₖ should be determined first to determine the dual variable dₖ, and the directionalities of the active interference information ĉₖ and the dual variable dₖ for optimizing the beamforming vector are different, a technique of separately using two neural network models is proposed. Hereinafter, embodiments of the present invention will be described in detail with reference to FIGS. 2 to 9.

FIG. 2 is a view showing the configuration of a beamforming vector generation apparatus 100 (hereinafter, referred to as an ‘apparatus 100’) according to an embodiment. The beamforming vector generation apparatus 100 may be provided in each base station constituting the MISO IC system to control the beamforming vector of each base station.

Referring to FIG. 2, the apparatus 100 according to an embodiment may each include a memory 110, a processor 120, an input/output interface 130, and a communication interface 140.

The memory 110 may store data acquired from an external device or data generated by itself. The memory 110 may store instructions that can perform the operation of the processor 120. In addition, the memory 110 may store information related to the MISO IC (e.g., number of base stations, etc.) and local channel information and weight information of the base station on which the apparatus 100 is mounted.

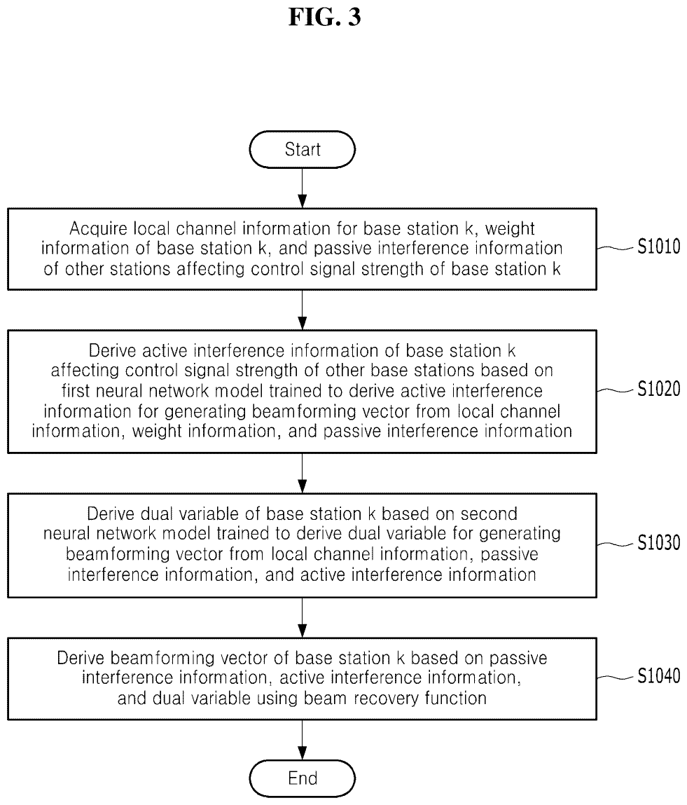

The processor 120 is a computing device that controls overall operations. The processor 120 may execute the instructions stored in the memory 110. According to an embodiment of this document, the operation of the apparatus 100 shown in FIG. 3, which will be described below, may be understood as an operation performed by the processor 120.

The input/output interface 130 may include a hardware interface or a software interface for inputting or outputting information.

The communication interface 140 allows information to be transmitted and received through a communication network. To this end, the communication interface 140 may include a wireless communication module or a wired communication module.

The apparatus 100 may be implemented as a variety of devices capable of performing operations through the processor 120 and transmitting and receiving information through a network. For example, the apparatus may be implemented in the form of a server, a computer device, a portable communication device, a smart phone, a portable multimedia device, a laptop computer, a tablet PC, or the like, but it is not limited to these examples.

FIG. 3 is a flowchart of operations performed by the apparatus 100 according to an embodiment. The operations of the apparatus 100 according to an embodiment of FIG. 3 may be understood as operations performed by the processor 120.

Each step disclosed in FIG. 3 is only a preferred embodiment for achieving the objects of the present invention, and some steps may be added or deleted as needed, and any one step may be included and performed in another step. The order of each operation disclosed in FIG. 3 is only an order arranged for convenience of understanding, and this order is not limited to a chronological order, and the order may be changed according to the selection of the designer to operate in a different order.

Referring to FIG. 3, at step S1010, the apparatus 100 may acquire local channel information hₖ for the k-th base station (hereinafter, referred to as ‘base station k’, where k is the identification information of the base station) among a plurality of base stations constituting the MISO IC system, weight information μₖ of base station k, and passive interference information čₖ.

The local channel information hₖ for base station k is Channel State Information (CSI) of base station k affecting other receivers, and the apparatus 100 may acquire the local channel information described above from the outside or may store it in advance. At this point, the local channel information may include local channel information hₖₖ of base station k affecting the base station of its own and local channel information hₖⱼ of base station k affecting base station j (=other base stations, k≠j).

The weight information μₖ of base station k is information set in advance for base station k among the base stations constituting the MISO IC, and the apparatus 100 may acquire weight information from the outside or store it in advance.

The passive interference information čₖ is interference temperature constraint information of base station j (=other base stations, k≠j) affecting the control signal strength of base station k. At the initial operation of the MISO IC system, the apparatus 100 may use a preset value (e.g., initial value) as the passive interference information čₖ. While the MISO IC system is in operation, the apparatus 100 may acquire the passive interference information čₖ (=active interference information ĉₖ, from the perspective of other base stations, generated by other base stations through step S1020 described below) through backhaul cooperation from other base stations.

Accordingly, in the embodiment of the present invention be described below, an optimal beamforming vector may be generated using a neural network trained based on the active interference information ĉₖ, passive interference information čₖ, and dual variable dₖ as the interference temperature constraint configured of scalar information, which is also a feature value reflecting the local channel information, weight information, and distributed information of base stations constituting a MISO IC described below.

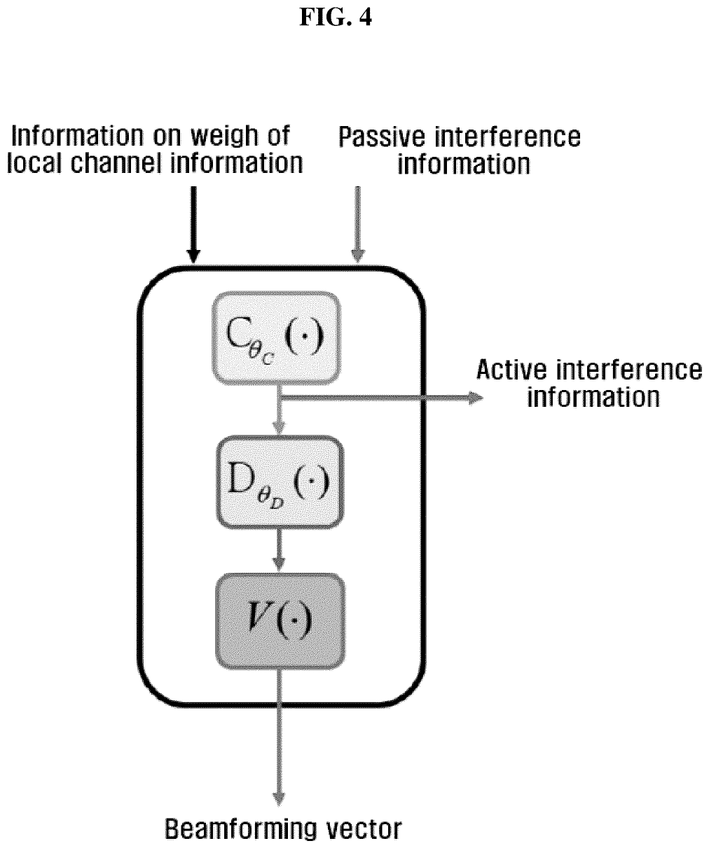

The embodiment described below presents, together with FIG. 4, an embodiment that separately uses two neural network models at steps S1020 and S1030 according to the point that the directionalities of the active interference information ĉₖ and the dual variable dₖ for optimizing the beamforming vector in [Equation 3] described above are different.

FIG. 4 is an exemplary view showing an operation of deriving a beamforming vector by dividing two neural network models by the apparatus 100 according to an embodiment of the present invention. In FIG. 4, [symbol] _{θ}_{_{C}}(⋅) represents a first neural network model, [symbol] _{θ}_{_{D}}(⋅) represents a second neural network model, and V(⋅) denotes a beam recovery function.

At step S1020, the apparatus 100 may derive active interference information ĉₖ of base station k affecting the control signal strength of other base stations based on the first neural network model trained to derive active interference information for generating a beamforming vector wₖ of a preset purpose (e.g., a beamforming vector satisfying the condition of [Equation 3] described above) from the local channel information hₖ, weight information μₖ, and passive interference information čₖ.

For example, the first neural network model is a model trained based on a predetermined deep learning algorithm and may include all types of models having problem-solving capabilities, which is configured of artificial neurons that form a network by combining synapses. An artificial neural network may be designed according to the connection pattern between neurons in different layers, a learning process that updates model parameters, and an activation function that generates output values.

The artificial neural network may include an input layer, an output layer, and one or more optional hidden layers. Each layer may include one or more neurons, and the artificial neural network may include synapses connecting the neurons. In the artificial neural network, each neuron may output a function value of an activation function for the input signals, weights, and biases input through synapses.

The model parameters mean parameters determined through learning, and may include weights of synaptic connections, biases of neurons, and the like. In addition, hyperparameters mean parameters that should be set before learning in a machine learning algorithm, and may include a learning rate, the number of learnings (epochs), a batch size, an initialization function, and the like.

For example, the parameters of the first neural network model may be learned in a direction that maximizes the expected value of the achievable transmission rate (e.g., WSR, WMR) of the base station according to a predetermined objective function, and learned in a supervised mode to derive active interference information for generating a beamforming vector of a preset purpose from the local channel information, weight information, and passive interference information.

For example, the objective function of the first neural network model may include [Equation 6] based on the first term on the right side of [Equation 3] described above.

$${J}_{C}^{[ t ]} ( {θ}_{C} ) = {𝔼}_{ℋ , ℳ} [ u ( \{ {r}_{k}^{[ t - 1 ]} ( {h}_{k} , {{c}^{⋁}}_{k} , {\hat{c}}_{k} ) : {∀}_{k} \} , μ ) ] \qquad [ Equation 6 ]$$

$$where {r}_{k}^{[ t ]} ( {h}_{k} , {{c}^{⋁}}_{k} , {\hat{c}}_{k} ) = {log}_{2} ( 1 + \frac{{\vert {h}_{kk}^{H} V ( {h}_{k} , {{c}^{⋁}}_{k}^{[ t - 1 ]} , {d}_{k}^{[ t ]} ) \vert}^{2}}{{\sum }_{j \neq k} {c}_{jk}^{[ t - 1 ]} + {σ}^{2}} )$$

$${d}_{k}^{[ t ]} = {𝒟}_{{θ}_{D}^{[ t ]}} ( {h}_{k} , {{c}^{⋁}}_{k}^{[ t - 1 ]} , {\hat{c}}_{k}^{[ t ]} )$$

$${{c}^{⋁}}_{k}^{[ t ]} {=}^{Δ} \{ {c}_{jk}^{[ t ]} : ∀ j \neq k \}$$

(J_{c} is the first neural network model, θ_{c} is the parameter of the first neural network model, [t] is the epoch order, h is the local channel information, č in c is the passive interference information of other base stations affecting the control signal strength of base station k, d is the dual variable, subscript k is the identification information of the base station, subscript kj is the subscript indicating information on base station k affecting base station j, subscript H is the dataset of the local channel information of base station k, and subscript M is the dataset of the weight information of base station k.)

For example, the apparatus 100 may learn the parameters of the first neural network model so that the loss function for the difference between the output value of the neural network model based on the objective function of the first neural network model and the actual correct answer value based on the dataset is minimized according to [Equation 6], which is the objective function of the first neural network function described above. The apparatus 100 may update the weight of the first neural network model in a direction that minimizes the gradient of the loss function at the learning step, and this may be accomplished through an error backpropagation process at each learning step.

The first neural network model trained in this way may be used at step S1020 described above, and the apparatus 100 may be provided in base station k to derive active interference information.

At step S1030, the apparatus 100 may derive the dual variable dₖ of base station k based on the second neural network model trained to derive dual variable for generating a beamforming vector wₖ of a preset purpose (e.g., a beamforming vector satisfying the condition of [Equation 3] described above) from local channel information hₖ, passive interference information čₖ, and active interference information ĉₖ generated at step S1020.

For example, the second neural network model is a model trained based on a predetermined deep learning algorithm and may include all types of models having problem-solving capabilities, which is configured of artificial neurons that form a network by combining synapses. An artificial neural network may be designed according to the connection pattern between neurons in different layers, a learning process that updates model parameters, and an activation function that generates output values.

The artificial neural network may include an input layer, an output layer, and one or more optional hidden layers. Each layer may include one or more neurons, and the artificial neural network may include synapses connecting the neurons. In the artificial neural network, each neuron may output a function value of an activation function for the input signals, weights, and biases input through synapses.

The model parameters mean parameters determined through learning, and may include weights of synaptic connections, biases of neurons, and the like. In addition, hyperparameters mean parameters that should be set before learning in a machine learning algorithm, and may include a learning rate, the number of learnings (epochs), a batch size, an initialization function, and the like.

For example, the parameters of the second neural network model may be learned in a direction that minimizes the expected value of the dual variable according to a predetermined objective function (since the signs of the second and third terms including the dual variable are ‘-’ according to [Equation 3]), and learned in a supervised mode to derive the dual variable for generating a beamforming vector of a preset purpose from the local channel information, passive interference information, and active interference information.

For example, the objective function of the second neural network model may include [Equation 7] based on the second and third terms on the right side of [Equation 3] described above.

$${J}_{D}^{[ t ]} ( {θ}_{D} ) = \frac{1}{K} {\sum }_{k = 1}^{K} {𝔼}_{{ℋ}_{k} , {ℳ}_{k}} [ {q}^{( t )} ( {h}_{k} , {d}_{k} ) ] \qquad [ Equation 7 ]$$

$$where {q}^{[ t ]} ( {h}_{k} , {d}_{k} ) {=}^{Δ} - {\sum }_{j \neq k} {d}_{kj} ( {\vert {h}_{kj}^{H} V ( {h}_{k} , {{c}^{⋁}}_{k}^{[ t ]} , {d}_{k}^{[ t - 1 ]} ) \vert}^{2} - {c}_{kj}^{[ t ]} )$$

$$- {d}_{kk} ( {‖ V ( {h}_{k} , {{c}^{⋁}}_{k}^{[ t ]} , {d}_{k}^{[ t - 1 ]} ‖}^{2} - P )$$

(J_{D} is the second neural network model, θ_{D} is the parameter of the second neural network model, t is the number of epochs, K is the number of base stations constituting the MISO IC, h is the local channel information, č in c is the passive interference information of other base stations affecting the control signal strength of base station k, d is the dual variable, V is the beam recovery function, subscript k is the identification information of the base station, subscript kj is the subscript indicating information on base station k affecting base station j, subscript Hₖ is the dataset of the local channel information of base station k, and subscript Mₖ is the dataset of the weight information of base station k.)

The apparatus 100 may learn the parameters of the second neural network model so that the loss function for the difference between the output value of the neural network model based on the objective function of the second neural network model and the actual correct answer value based on the dataset is minimized according to [Equation 7], which is the objective function of the second neural network function described above. The apparatus 100 may update the weight of the second neural network model in a direction that minimizes the gradient of the loss function at the learning step, and this may be accomplished through an error backpropagation process at each learning step.

The second neural network model learned in this way may be applied to step S1030 described above, so that a dual variable can be derived from a base station equipped with the apparatus 100.

Meanwhile, as the first neural network model and the second neural network model are alternately trained in a method of learning the second neural network model after learning the first neural network model for each order of epoch during the learning process using the same data set of local channel information and data set of weight information, each parameter may be updated by the same samples of local channel information and weight information for each epoch order.

At step S1040, the apparatus 100 may derive a beamforming vector wₖ satisfying a preset purpose (=Equation 3) based on the passive interference information čₖ, active interference information ĉₖ, and dual variable dₖ using a beam recovery function V(⋅). At this point, various types of known beam recovery functions may be used as the beam recovery function, and for example, the beam recovery function may include the beam recovery function of the non-patent document described as a prior art of this document.

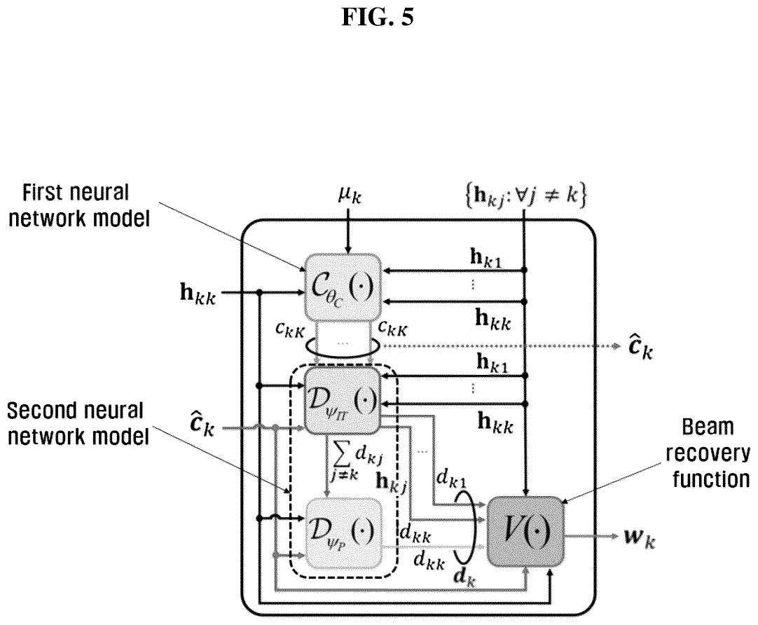

FIG. 5 is an exemplary view specifically showing input variables and output variables of a first neural network model, a second neural network model, and a beam recovery function according to an embodiment. In FIG. 5, [symbol] _{θ}_{_{C}}(⋅) denotes the first neural network model. Since the second neural network model is divided into a term for obtaining the dual variable dₖⱼ, which is one of the dual variable dₖ included in the objective function of [Equation 7], and a term for obtaining the other one dₖₖ, the second neural network model [symbol] _{θ}_{_{D}}(⋅) is divided based on each dual variable to be expressed as [symbol] _{ψIT}(⋅) and [symbol] _{ψP}(⋅). V(⋅) denotes a beam multiple function.

Referring to FIG. 5, the apparatus 100 may generate active interference information cₖⱼ (cₖ₁ to c_{kK}) by inputting local channel information hₖ (hₖ₁ to c_{kK}) and weight information μₖ into the first neural network model [symbol] _{θ}_{_{C}}(⋅). The active interference information cₖⱼ may adjust interference power |hₖⱼ^{H}wₖ|² generated from base station k to base station j.

According to the explanation described above, the relation of the input and output information of the first neural network model is summarized as shown in [Equation 8].

$${c}_{kj} = {𝒞}_{{θ}_{C}} ( {h}_{kk} , {h}_{kj} , {μ}_{k} ) . \qquad [ Equation 8 ]$$

Meanwhile, since the input and output dimensions of the first neural network model are unrelated to the network size K, it can be seen that it is scalable for an arbitrary number of base stations K. Since cₖⱼ acts as the upper limit of the interference signal power |hₖⱼ^{H}wₖ|², cₖⱼ exists in the section of [0, P∥hₖⱼ∥²]. This constraint can be resolved by using a sigmoid function in the output layer of the artificial neural network and multiplying the output that has passed through the sigmoid function by P∥hₖⱼ∥². Meanwhile, the active interference information cₖⱼ is utilized as a scalar cooperation message transmitted from base station k to base station j that gives interference. That is, base station j may use the active interference information generated by base station k as passive interference information for the base station of its own. This applies to all j≠k. Therefore, the active interference information ĉₖ may be derived as shown in [Equation 9] through K−1 times of parallel operation of [Equation 8].

$${\hat{c}}_{k} = \{ {𝒞}_{{θ}_{C}} ( {h}_{kk} , {h}_{kj} , {μ}_{k} ) : {∀}_{j} \neq k \} \qquad [ Equation 9 ]$$

Referring to FIG. 5 again, in utilizing the second neural network model, the apparatus 100 utilizes the passive interference information čₖ to generate the dual variable dₖ. As shown in [Equation 7], which is the objective function of the second neural network model described above, the dual variable dₖ includes two types of dual variables dₖⱼ and dₖₖ. Specifically, {dₖⱼ:∀j≠k} is related to an interference temperature constraint on an interference base station, and dₖₖ adjusts the power constraint of base station k. Since these heterogeneous functions of the dual variables require different calculation procedures, it will be described by dividing the second neural network model [symbol] _{θ}_{_{D}}(⋅) into [symbol] _{ψ1T}(⋅) and [symbol] _{ψP}(⋅). At this point, as trainable parameters ω_{IT} and ω_{P} of [symbol] _{ψIT}(⋅) and [symbol] _{ωP}(⋅) form θ_{d}={ω_{IT}, ω_{P}} together, the dual variable {dₖⱼ:∀j≠k} and dₖₖ may be determined.

First, [symbol] _{ωIT}(⋅) that determines dₖⱼ will be described. According to the Lagrange duality analysis of [Equation 4] described above, the optimal dual variable minimizes the dual function g(.). Therefore, dₖⱼ may be iteratively optimized according to the partial gradient of Lagrange.

$${\partial }_{{d}_{kj}} L ( {w}_{k} , {d}_{k} ; {h}_{k} , {{c}^{⋁}}_{k} , {\hat{c}}_{k} ) \vert {w}_{k} = V ( {h}_{k} , {{c}^{⋁}}_{k} , {d}_{k} ) = {c}_{kj} - {\vert {h}_{kj}^{H} V ( {h}_{k} , {{c}^{⋁}}_{k} , {d}_{k} ) \vert}^{2} \qquad [ Equation 10 ]$$

Next, [symbol] _{ψP}(⋅) that determines dₖₖ will be described. In [Equation 4] described above, dₖₖ adjusts the transmission power of base station k, i.e., ∥wₖ∥², by adjusting the power control variable pₖ. Therefore, the input value of [symbol] _{ωP}(⋅) should include hₖₖ and Σ_{j≠k} cⱼₖ. In addition, the weighted sum Σ_{j≠k} dₖⱼhₖⱼ of the interference channels required to extract the latent features of Aₖ is selected as the input in the equation 4. According to this insight, [symbol] _{ψP}(⋅): [symbol] ^{M}^{_{T}}× [symbol] ^{M}^{_{T}}× [symbol] → [symbol] may be defined as shown in [Equation 11].

$${d}_{kk} = {𝒟}_{{ψ}_{P}} ( {h}_{kk} , {\sum }_{j \neq k} {d}_{kj} {h}_{kj} , {\sum }_{j \neq k} {c}_{jk} ) \qquad [ Equation 11 ]$$

At this point, to ensure the condition that the dual variable should be positive, the softplus activation function may be used in the output layers of [symbol] _{ψIT}(⋅) and [symbol] _{ψP}(⋅).

The apparatus 100 may obtain beam feature values (ĉₖ, čₖ, dₖ) by utilizing the first neural network model [symbol] _{θ}_{_{C}}(⋅) and the second neural network model [symbol] _{θ}_{_{D}}(⋅). Accordingly, the beam recovery function V(.) may calculate wₖ based on the beam feature values. The distributed operation like this may define the final beam forming optimizer operation [symbol] _{θ}(⋅) as shown in [Equation 12].

$$W = \{ {w}_{k} : ∀ k \} = {𝒱}_{θ} ( H , μ ) {=}^{Δ} \{ V ( {h}_{k} , {{c}^{⋁}}_{k} , {d}_{k} ) : ∀ k \} \qquad [ Equation 12 ]$$

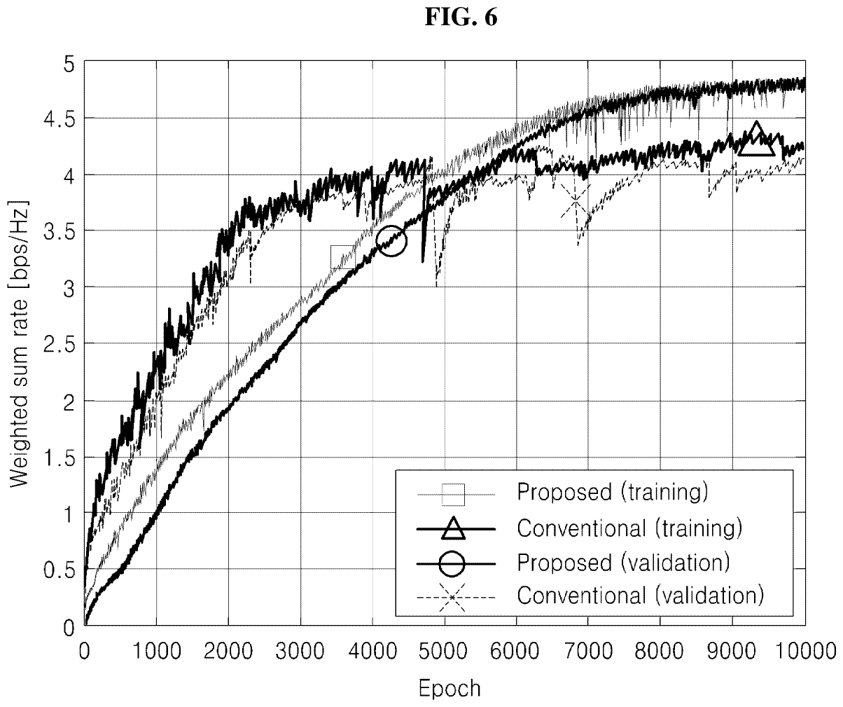

FIG. 6 is an exemplary view comparing performance for WSR when performing an embodiment (Proposed) using a neural network model divided into two according to an embodiment of this document and an embodiment (Conventional) using a neural network model by setting [Equation 3] itself as a single objective function.

Referring to FIG. 6, it can be confirmed that as the order of epoch increases, an embodiment of learning by dividing a neural network model into two according to the objective function as shown in the embodiment of this document may achieve a higher WSR, compared to an embodiment of setting [Equation 3] itself as one objective function.

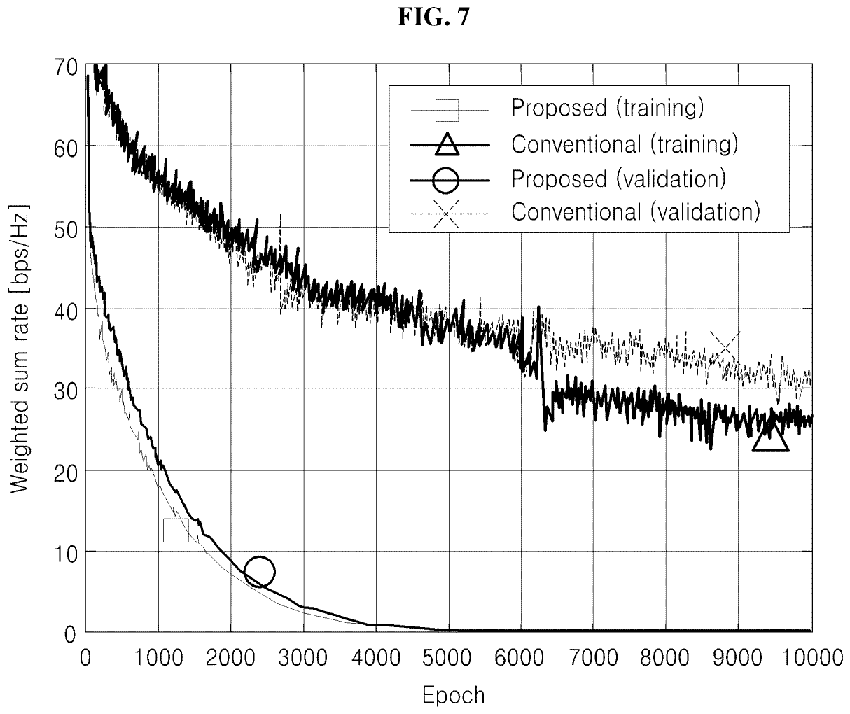

FIG. 7 is an exemplary view comparing performance for Dual Convergence when performing an embodiment (Proposed) using a neural network model divided into two according to an embodiment of this document and an embodiment (Conventional) using a neural network model by setting [Equation 3] itself as a single objective function.

Referring to FIG. 7, it can be confirmed that as the order of epoch increases, an embodiment of learning by dividing a neural network model into two according to the objective function as shown in the embodiment of this document may achieve higher performance by converging to Duality Gap 0, compared to an embodiment of setting [Equation 3] itself as one objective function.

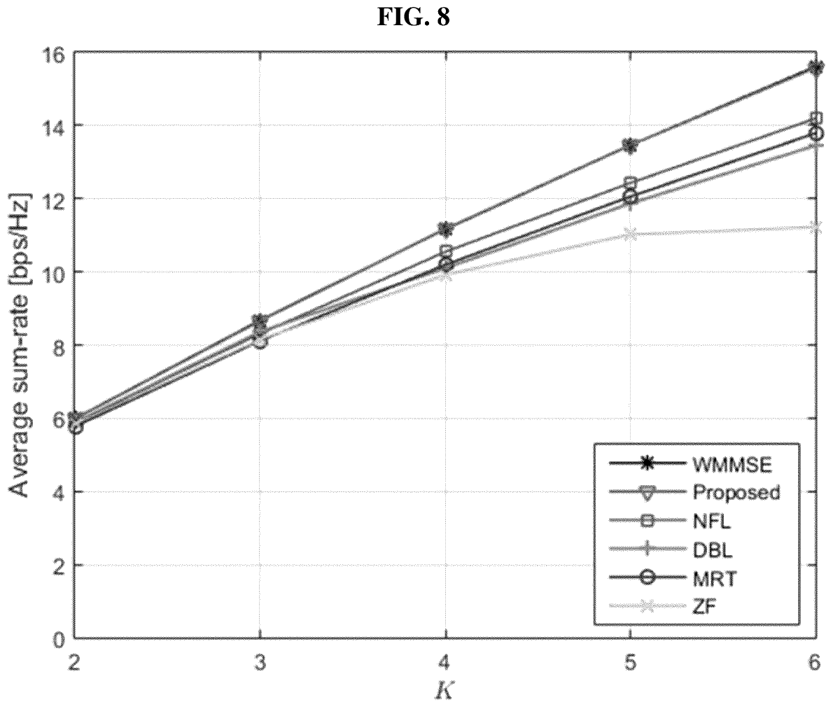

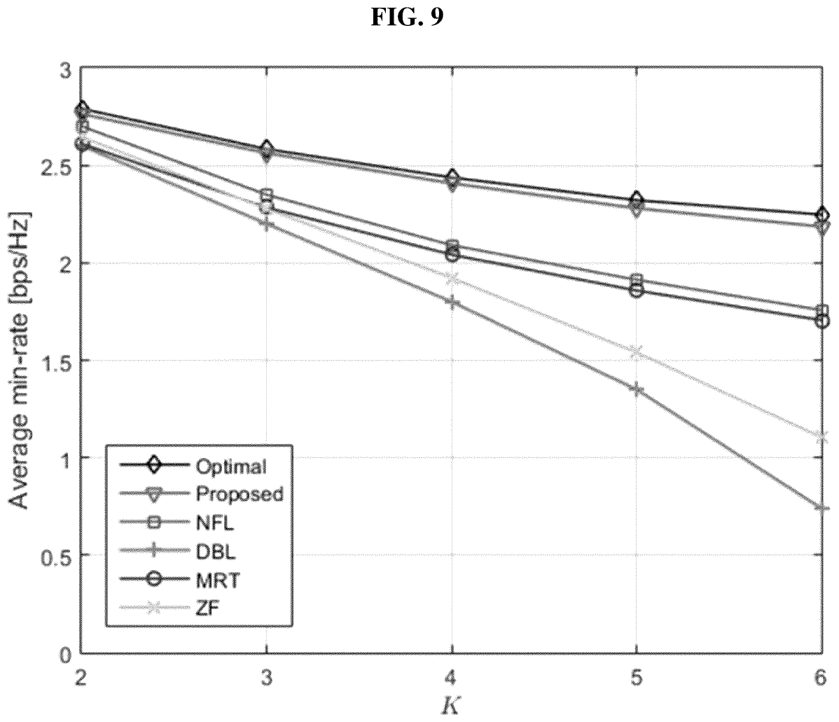

FIGS. 8 and 9 are exemplary views comparing performances of ASR and AMR based on a centralized method (Optimal) of generating a beamforming vector, an embodiment of this document (Proposed), and conventional methods (NFL, DBL, MRT, ZF), respectively.

Referring to FIGS. 8 and 9, it can be confirmed that performance (Proposed) of the present invention exhibits performance almost similar to that of the centralized control method (Optimal) although it uses a distributed optimization technique. In other words, it can be confirmed that the present invention may exhibit performance corresponding to the centralized control method while performing control determination much faster compared to the centralized control method.

According to an embodiment described above, the present invention may reduce computational complexity while improving performance of the beamforming technique by designing an artificial neural network structure using local channel information, which can be secured in each base station in a multi-antenna interference channel system, and feature values essential for beamforming determination.

In addition, since the distributed beamforming technique of the present invention uses local channel information that can be secured in each base station, it may significantly reduce backhaul overheads for information exchange, compared to conventional deep learning-based beamforming techniques that require global CSI.

Accordingly, the present invention can be expanded without degradation of performance even when the number of base stations increases, and allows efficient interference management and high network performance as excellent performance is shown even in various channel environments.

It should be understood that various embodiments of this document and the terms used herein are not intended to limit the technical features described in this document to specific embodiments, but include various modifications, equivalents, or substitutes of the embodiments. In connection with the description of drawings, similar reference numerals may be used for similar or related components. The singular form of a noun corresponding to an item may include one or more items, unless the related context clearly indicates otherwise.

In this document, each of phrases such as “A or B”, “at least one among A and B”, “at least either A or B”, “A, B, or C”, “at least one among A, B, and C”, and “at least either A, B, or C” may include all possible combinations of the items listed together in a corresponding phrase among the phrases. Terms such as “1st”, “2nd”, “first”, or “second” may be used only to distinguish a corresponding component from another corresponding component, and do not limit the components in any other aspect (e.g., importance or order). When a certain (e.g., a first) component is referred to as being “coupled” or “connected” to another (e.g., a second) component with or without a term such as “functionally” or “communicatively”, it means that the component may be connected to another component directly (e.g., wired), wirelessly, or through a third component.

The term “module” used in this document may include a unit implemented in hardware, software, or firmware, and may be used interchangeably with terms such as logic, logic block, part, or circuit. A module may be an integrally configured component, or a minimum unit of a component or a portion thereof that performs one or more functions. For example, according to an embodiment, a module may be implemented in the form of an application-specific integrated circuit (ASIC).

Various embodiments of this document may be implemented as software (e.g., a program) including one or more instructions stored in a storage medium (e.g., a memory) that can be read by a device (e.g., an electronic device). The storage medium may include a random-access memory (RAM), a memory buffer, a hard drive, a database, an erasable programmable read-only memory (EPROM), an electrically erasable read-only memory (EEPROM), a read-only memory (ROM), and/or the like.

In addition, the processor in the embodiments of this document may call at least one command among one or more stored commands from the storage medium and execute the command. This allows the device to operate to perform at least one function according to the called at least one command. The one or more commands may include a code generated by a compiler or a code that can be executed by an interpreter. The processor may be a general-purpose processor, a Field Programmable Gate Array (FPGA), an Application Specific Integrated Circuit (ASIC), a Digital Signal Processor (DSP), and/or the like.

The storage medium that can be read by a device may be provided in the form of a non-transitory storage medium. Here, ‘non-transitory’ only means that the storage medium is a tangible device and does not include signals (e.g., electromagnetic waves), and this term does not distinguish the cases where data is stored semi-permanently on the storage medium from the cases where data is stored temporarily.

The method according to various embodiments disclosed in this document may be provided to be included in a computer program product. The computer program product may be traded between a seller and a buyer as goods. The computer program product may be distributed in the form of a machine-readable storage medium (e.g., a compact disc read only memory (CD-ROM)), or may be distributed online (e.g., downloaded or uploaded) through an application store (e.g., Play Store) or directly distributed between two user devices (e.g., smart phones). In the case of online distribution, at least a part of the computer program product may be at least temporarily stored in a machine-readable storage medium, such as a memory of a manufacturer's server, an application store's server, or a server, or may be temporarily generated.

According to various embodiments, each component (e.g., a module or a program) of the components described above may include a single or a plurality of entities. According to various embodiments, one or more of the components or operations of the components described above may be omitted, or one or more other components or operations may be added. Alternatively or additionally, a plurality of components (e.g., modules or a programs) may be integrated into a single component. In this case, the integrated component may perform one or more functions of each of the plurality of components in a way identical or similar to those performed by the corresponding component among the plurality of components before the integration. According to various embodiments, the operations performed by the modules, programs, or other components may be executed sequentially, in parallel, repeatedly, or heuristically, or one or more of the operations may be executed in a different order or omitted, or one or more other operations may be added.

Accordingly, the present invention is scalable without degradation of performance even when the number of base stations increases, and allows efficient interference management and high network performance as excellent performance is shown even in various channel environments.

The present invention may reduce computational complexity while improving performance of the beamforming technique by designing an artificial neural network structure using local channel information that can be secured in each base station in a multi-antenna interference channel system and feature values essential for beamforming determination.

In addition, since the distributed beamforming technique of the present invention uses local channel information that can be secured in each base station, it can significantly reduce backhaul overhead for information exchange, compared to conventional deep learning-based beamforming techniques that require global CSI.

Meanwhile, the effects of the present invention are not limited to those mentioned above, and unmentioned other technical effects will be clearly understood by those skilled in the art from the following description.

### DESCRIPTION OF SYMBOLS

100: Apparatus
110: Memory
120: Processor
130: Input/Output Interface
140: Communication Interface

What is claimed is:

1. A method performed by a beamforming vector generation apparatus operated by a processor, the method comprising:
an operation of acquiring local channel information for base station k (k is identification information of a base station) among base stations constituting a MISO IC, weight information of base station k, and passive interference information of other base stations affecting a control signal strength of base station k;
an operation of deriving active interference information of base station k affecting a control signal strength of other base stations based on a first neural network model learned to derive active interference information for generating a beamforming vector of a preset purpose from the local channel information, the weight information, and the passive interference information;
an operation of deriving a dual variable of base station k based on a second neural network model trained to derive a dual variable for generating a beamforming vector of a preset purpose from the local channel information, the passive interference information, and the active interference information; and
an operation of deriving a beamforming vector of base station k based on the passive interference information, the active interference information, and the dual variable using a beam recovery function.

2. The method according to claim 1, wherein the local information for base station k includes Channel State channel Information (CSI) of base station k affecting other receivers, and the weight information of base station k includes weight information set in advance for base station k among the base stations constituting the MISO IC.

3. The method according to claim 1, wherein the first neural network model and the second neural network model are trained based on an interference temperature constraint configured of scalar information as a feature value reflecting distribution information of base stations constituting the MISO IC, and each of the base stations constituting the MISO IC includes the same first neural network model and second neural network model.

4. The method according to claim 1, wherein the beamforming vector of a preset purpose is a beamforming vector that maximizes an achievable transmission rate that can be achieved by base station k based on [Equation 1],
$${R}_{k} ( H , W ) = {log}_{2} ( 1 + \frac{{\vert {h}_{kk}^{H} {w}_{k} \vert}^{2}}{{\sum }_{j \neq k} {\vert {h}_{jk}^{H} {W}_{j} \vert}^{2} + {σ}^{2}} ) \qquad [ Equation 1 ]$$
$$where H {=}^{Δ} \{ {h}_{k} : {∀}_{k} \} ∈ {ℂ}^{{M}_{T} K \times K} ,$$
$$W {=}^{Δ} \{ {w}_{k} : {∀}_{k} \} ∈ {ℂ}^{{M}_{T} K \times K}$$
(r is the achievable transmission rate of a base station, w is the beamforming vector, h is the local channel information, c is interference information between base stations affecting the control signal strength, subscript k is the identification information of the base station, and subscript kj is a subscript indicating information on base station k affecting base station j).

5. The method according to claim 4, wherein conditions for achieving the beamforming vector of [Equation 1] include [Equation 2] to [Equation 4] shown below,
$$L ( {w}_{k} , {d}_{k} ; {h}_{k} , {{c}^{⋁}}_{k} , {\hat{c}}_{k} ) = {log}_{2} ( 1 + \frac{{\vert {h}_{kk}^{H} {w}_{k} \vert}^{2}}{{\sum }_{j \neq k} {c}_{jk} + {σ}^{2}} ) - {\sum }_{j \neq k} {d}_{kj} ( {\vert {h}_{kj}^{H} {w}_{k} \vert}^{2} - {c}_{kj} ) - {d}_{kk} ( {‖ {w}_{k} ‖}^{2} - P ) \qquad [ Equation 2 ]$$
(L is a Lagrangian function, w is the beamforming vector, h is the local channel information, c is the interference information between base stations affecting the control signal strength, čₖ in c is the passive interference information of other base stations affecting the control signal strength of base station k, ĉₖ in c is the active interference information of base station k affecting the control signal strength of other base stations, d is the dual variable, subscript k is the identification information of the base station, and subscript kj is a subscript indicating information on base station k affecting base station j),
$$g ( {d}_{k} ; {h}_{k} , {{c}^{⋁}}_{k} , {\hat{c}}_{k} ) = {max}_{{w}_{k}} L ( {w}_{k} , {d}_{k} ; {h}_{k} , {{c}^{⋁}}_{k} , {\hat{c}}_{k} ) \qquad [ Equation 3 ]$$
(g is the dual function, w is the beamforming vector, d is the dual variable, h is the local channel information, c is the interference information between base stations affecting the control signal strength, čₖ in c is the passive interference information of other base stations affecting the control signal strength of base station k, ĉₖ in c is the active interference information of base station k affecting the control signal strength of other base stations, subscript k is the identification information of the base station, and subscript kj is a subscript indicating information on base station k affecting base station j), and
$${w}_{k} = V ( {h}_{k} , {{c}^{⋁}}_{k} , {d}_{k} ) {=}^{Δ} \sqrt{{p}_{k}} {A}_{k}^{- 1} {h}_{kk} \qquad [ Equation 4 ]$$
$$where {A}_{k} {=}^{Δ} {\sum }_{j \neq k} {d}_{kj} {h}_{kj} {h}_{kj}^{H} + {d}_{kk} I$$
$${p}_{k} {=}^{Δ} {( \frac{1}{ln 2} - \frac{{\sum }_{j \neq k} {c}_{jk} + {σ}^{2}}{{‖ {A}_{k}^{- \frac{1}{2}} {h}_{kk} ‖}^{2}} )}^{+} \frac{1}{{‖ {A}_{k}^{- \frac{1}{2}} {h}_{kk} ‖}^{2}}$$
(w is the beamforming vector, V is the beam recovery function, h is the local channel information, čₖ in c is the passive interference information of other base stations affecting the control signal strength of base station k, d is the dual variable, subscript k is the identification information of the base station, and subscript kj is a subscript indicating information on base station k affecting base station j).

6. The method according to claim 1, wherein the first neural network model is trained in a direction that maximizes an expected value of an achievable transmission rate of the base station according to a predetermined objective function, and includes parameters learned to derive active interference information for generating a beamforming vector of the preset purpose from the local channel information, the weight information, and the passive interference information.

7. The method according to claim 6, wherein the objective function of the first neural network model includes [Equation 5],
$${J}_{C}^{[ t ]} ( {θ}_{C} ) = {𝔼}_{ℋ , ℳ} [ u ( \{ {r}_{k}^{[ t - 1 ]} ( {h}_{k} , {{c}^{⋁}}_{k} , {\hat{c}}_{k} ) : {∀}_{k} \} , μ ) ] \qquad [ Equation 5 ]$$
$$where {r}_{k}^{[ t ]} ( {h}_{k} , {{c}^{⋁}}_{k} , {\hat{c}}_{k} ) = {log}_{2} ( 1 + \frac{{\vert {h}_{kk}^{H} V ( {h}_{k} , {{c}^{⋁}}_{k}^{[ t - 1 ]} , {d}_{k}^{[ t ]} ) \vert}^{2}}{{\sum }_{j \neq k} {c}_{jk}^{[ t - 1 ]} + {σ}^{2}} )$$
$${d}_{k}^{[ t ]} = {𝒟}_{{θ}_{D}^{[ t ]}} ( {h}_{k} , {{c}^{⋁}}_{k}^{[ t - 1 ]} , {\hat{c}}_{k}^{[ t ]} )$$
$${{c}^{⋁}}_{k}^{[ t ]} {=}^{Δ} \{ {c}_{jk}^{[ t ]} : ∀ j \neq k \}$$
(J_{c} is the first neural network model, θ_{c} is the parameter of the first neural network model, t is the epoch order, h is the local channel information, č in c is the passive interference information of other base stations affecting the control signal strength of base station k, d is the dual variable, subscript k is the identification information of the base station, subscript kj is a subscript indicating information on base station k affecting base station j, subscript H is the dataset of the local channel information of base station k, and subscript M is the dataset of the weight information of base station k).

8. The method according to claim 1, wherein the second neural network model is trained in a direction that minimizes an expected value of a dual variable according to a predetermined objective function, and includes parameters learned to derive a dual variable for generating a beamforming vector of the preset objective from the local channel information, the passive interference information, and the active interference information.

9. The method according to claim 8, wherein the objective function of the second neural network model includes [Equation 6],
$${J}_{D}^{[ t ]} ( {θ}_{D} ) = \frac{1}{K} {\sum }_{k = 1}^{K} {𝔼}_{{ℋ}_{k} , {ℳ}_{k}} [ {q}^{( t )} ( {h}_{k} , {d}_{k} ) ] \qquad [ Equation 6 ]$$
$$where {q}^{[ t ]} ( {h}_{k} , {d}_{k} ) {=}^{Δ} - {\sum }_{j \neq k} {d}_{kj} ( {\vert {h}_{kj}^{H} V ( {h}_{k} , {{c}^{⋁}}_{k}^{[ t ]} , {d}_{k}^{[ t - 1 ]} ) \vert}^{2} - {c}_{kj}^{[ t ]} )$$
$$- {d}_{kk} ( {‖ V ( {h}_{k} , {{c}^{⋁}}_{k}^{[ t ]} , {d}_{k}^{[ t - 1 ]} ‖}^{2} - P )$$
(J_{D} is the second neural network model, θ_{D} is the parameter of the second neural network model, t is the number of epochs, K is the number of base stations constituting the MISO IC, h is the local channel information, č in c is the passive interference information of other base stations affecting the control signal strength of base station k, d is the dual variable, V is the beam recovery function, subscript k is the identification information of the base station, subscript kj is a subscript indicating information on base station k affecting base station j, subscript Hₖ is the dataset of the local channel information of base station k, and subscript Mₖ is the dataset of the weight information of base station k).

10. The method according to claim 1, wherein as the first neural network model and the second neural network model are alternately trained in a method of learning the second neural network model after learning the first neural network model for each epoch during the learning process using the same data set of local channel information and data set of weight information, each parameter is updated by the same samples of local channel information and weight information for each epoch.

11. A beamforming vector generation apparatus comprising:
a memory containing instructions; and
a processor performing predetermined operations based on the instructions, wherein
the operations of the processor include:
an operation of acquiring local channel information for base station k (k is identification information of a base station) among base stations constituting a MISO IC, weight information of base station k, and passive interference information of other base stations affecting a control signal strength of base station k;
an operation of deriving active interference information of base station k affecting a control signal strength of other base stations based on a first neural network model learned to derive active interference information for generating a beamforming vector of a preset purpose from the local channel information, the weight information, and the passive interference information;
an operation of deriving a dual variable of base station k based on a second neural network model trained to derive a dual variable for generating a beamforming vector of a preset purpose from the local channel information, the passive interference information, and the active interference information; and
an operation of deriving a beamforming vector of base station k based on the passive interference information, the active interference information, and the dual variable using a beam recovery function.
